(19) United States
(12) Patent Application Publication
(10) Pub. No.: US 2020/0028844 A1
(43) Pub. Date: Jan. 23, 2020

(54) SYSTEM AND METHOD FOR PERFORMING USER AUTHENTICATION

(71) Applicants: Frederic Aime, Nice (FR); Aurelia Bordas, Nice (FR)

(72) Inventors: Frederic Aime, Nice (FR); Aurelia Bordas, Nice (FR)

(73) Assignee: Animatech Ltd, Chelmsford (GB)

(21) Appl. No.: 16/040,577

(22) Filed: Jul. 20, 2018

(51) Int. Cl. H04L 29/06; H04L 9/32; G06Q 20/40; H04M 3/493; G06K 9/62; G06K 9/00

(52) U.S. Cl. CPC H04L 63/0861; H04L 63/083; H04L 9/3213; H04L 63/101; G06K 2009/00939; G06Q 20/4016; H04M 3/493; G06K 9/6215; G06K 9/00885; H04L 63/107

(57) ABSTRACT

A biometric solution based on cardiac activity (Heart Rate Variability) using advanced mathematical calculations, machine learning, or artificial intelligence identified from the forehead, measured through a camera lens on fixed and mobile devices, scopes, virtual reality headsets, rear view mirrors in vehicles and any device where a camera can be used to identify and authenticate a user and diagnostic indicators where needed. This technology can be combined with additional physical and behavioural biometric indicators for further identification, authentification and specific diagnostic readings. This technology will be used to identify individuals, authenticate users for secure online transactions, grant access to countries, facilities and documents granting an AnimaToken from the AnimaCloud. This technology can be used to determine changes in physical health and indicate the introduction of substances to the body.

This application is from the previous provisional: SYSTEM AND METHOD FOR PERFORMING USER AUTHENTICATION is officially “patent pending” with Provisional Patent Application No. 62/535,537.

### BACKGROUND

Enforcing the identity of someone has become a challenge in the Information Technology (IT) industry. Many companies worldwide are working to bring trust in online transactions. Some of the developed authentication technologies include fingerprint authentication, eye-print authentication (IRIS authentication,) vein-print authentication. However, these technologies are excessively expensive to be secure at the end points (e.g. smartphone, fingerprint reader). These technologies often use expensive sensors provide inaccurate precision and there is a possibility of falsification. Accordingly, there is a need for methods and systems for securely and efficiently perform user authentication.

### SUMMARY

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

According to some aspects, the present disclosure provides a biometric solution based on cardiac activity identified from the forehead, measured through a camera lens on fixed and mobile devices, scopes, virtual reality headsets, rear view mirrors in vehicles and any device where a camera can be used to identify and authenticate a user and diagnostic indicators where needed. This technology can be combined with additional physical and behavioural biometric indicators for further identification, authentification and specific diagnostic readings. The disclosed solution increases the trust in IDM/Auth platforms. Further, the disclosed solution is easy to add to existing solutions regardless technology by connecting through standards. According to some aspects, the present disclosure ensures maximum level of trust by computing an “Anima ID” (a token).

The “Anima ID” is a global authentication token which can be used for peer applications, blockchain transactions and securing cryptocurrency wallets. The computed token is an entity as itself, so it can be transported through any available means in the IT industry.

According to some aspects, the present disclosure employs several techniques combined to achieve the business goal which is to enforce the identity, authenticate and collect diagnostic readings of a user by reading user's Heart Rate Variability (HRV). The techniques may include high-end mathematical processing, biometric data, high-end computing and artificial intelligence with state of the art computing environments.

According to some aspects, Heart Rate Variability (HRV) is cleaned before authentication is performed. The cleaning of the heart rate data is performed by using high-end techniques such as the Quasi-Newton optimization.

Further, other techniques developed for Heart Rhythm analysis may be used, the techniques may be specifically designed to identify anomalies in heartbeat data. According to some aspects, a big data and deep learning architecture is used to search for the tokens “Anima ID” in a cloud storage “Anima Cloud”.

Both the foregoing summary and the following detailed description provide examples and are explanatory only. Accordingly, the foregoing summary and the following detailed description should not be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose. Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 is a schematic showing a process to authenticate users, in accordance with some embodiments.

FIG. 3 is a flowchart of a method for authenticating users, in accordance with an exemplary embodiment.

FIG. 4 is a schematic showing a process to authenticate users, in accordance with an exemplary embodiment.

FIG. 5 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure.

Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof.

It is not intended that the scope of patent protection be defined by reading into any claim a limitation found herein that does not explicitly appear in the claim itself. Thus, for example, any sequence(s) and/or temporal order of steps of various processes or methods that are described herein are illustrative and not restrictive.

Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention.

Accordingly, it is intended that the scope of patent protection is to be defined by the issued claim(s) rather than the description set forth herein. Additionally, it is important to note that each term used herein refers to that which an ordinary artisan would understand such term to mean based on the contextual use of such term herein.

To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible.

For example, substitutions, additions, or modifications may be made to the elements illustrated in the drawings, and the methods described herein may be modified by substituting, reordering, or adding stages to the disclosed methods. Accordingly, the following detailed description does not limit the disclosure.

Instead, the proper scope of the disclosure is defined by the appended claims. The present disclosure contains headers. It should be understood that these headers are used as references and are not to be construed as limiting upon the subjected matter disclosed under the header. The present disclosure includes many aspects and features.

Moreover, while many aspects and features relate to, and are described in, the context of user authentication, embodiments of the present disclosure are not limited to use only in this context.

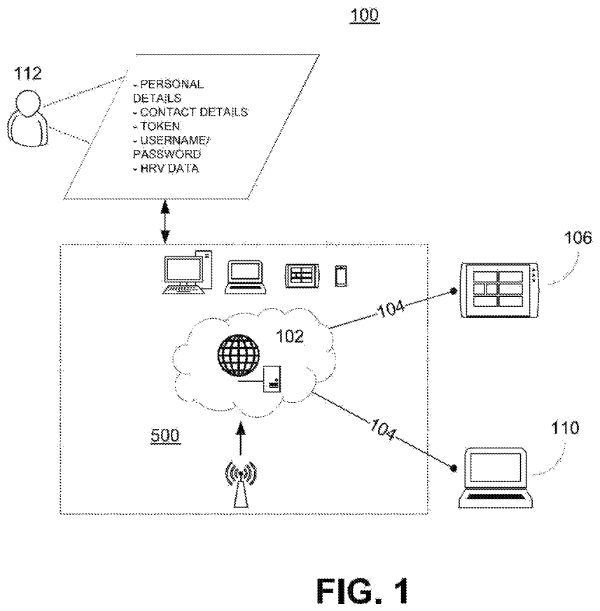

FIG. 1 is an illustration of an online platform 100 consistent with various embodiments of the present disclosure. By way of non-limiting example, the online platform 100 for authenticating users may be hosted on a centralized server 102, such as, for example, a cloud computing service. The centralized server 102 may communicate with other network entities, such as, for example, a mobile device 106 (such as a smartphone, a laptop, a tablet computer etc.) and other electronic devices 110 (such as desktop computers, server computers etc.) over a communication network 104, such as, but not limited to, the Internet.

Further, users of the platform may include relevant parties such as one or more of users and administrators and so on. Accordingly, electronic devices operated by the one or more relevant parties may be in communication with the platform. For example, the mobile device 106 may be operated by a user trying to login into an online service (such as a bank website). A user 112, such as the one or more relevant parties, may access platform 100 through a software application.

The software application may be embodied as, for example, but not be limited to, a website, a web application, a desktop application, and a mobile application compatible with a computing device 500.

Subsequently, the platform provides a biometric user authentication solution based on cardiac activity. The solution is based on proven scientific facts. Therefore, the disclosed solution increases trust in IDM/Auth platforms. Further, it is easy to integrate the disclosed solution with existing solutions regardless of the technology by connecting through the respective standard specifications (such as pre-defined APIs).

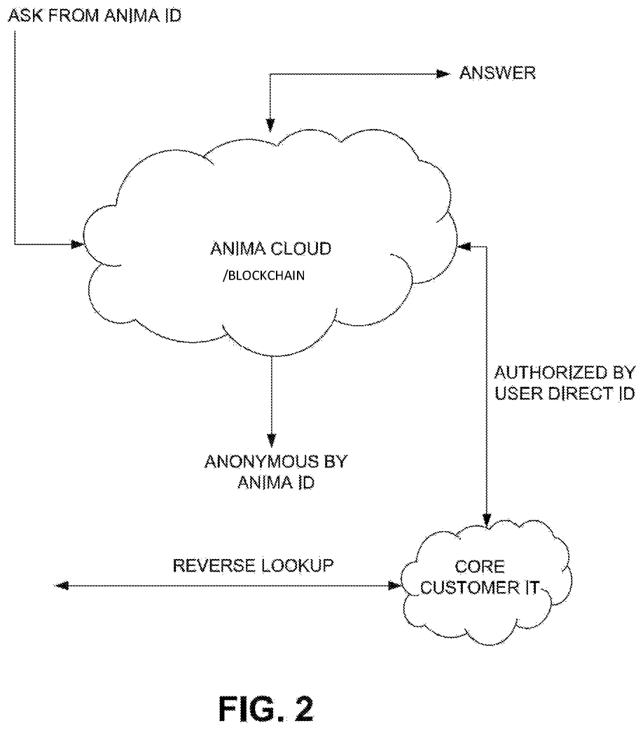

FIG. 2 is a schematic showing a process to authenticate users, in accordance with some embodiments. A cloud-based strong authentication solution is provided, which may include a cloud system called “Anima Cloud”. The cloud-based strong authentication solution enables software applications, peer to peer networks (not restricted to but including blockchain) to authenticate users. A user may ask for an “Anima ID” (may also be called AnimaTech Token Factory (ATF) token) by sending a request to the “Anima Cloud”. The “Anima ID” provides a unique identity marker for a specific user.

The “Anima ID” is global authentication token which may be used with peer applications. Further, the “Anima ID” is an entity as itself, so it can be transported through any available means in the IT industry. The user request may include one or more of personal details, contact details, and heart rate variability (HRV) data. HRV is the interval from one beat to another (peak to peak).

The variability of those intervals is a representation of the functioning of the vagal 25 system (autonomous nervous system). Therefore, HRV is different from Electro Cardiogram and heart rate. The “Anima Cloud” may compute the “Anima ID” based on the information provided in the user request. Further, the “Anima Cloud” may store the “Anima ID” in the cloud storage and may also send the “Anima ID” to the user.

Thereafter, the “Anima ID” may be anonymously sent to software applications (by the “Anima Cloud”) where the user requests for the user authentication. Further, the software applications may use multiple factor authentication, wherein, in addition to the “Anima ID”, the user may be required to enter a username and password or perform another authentication step using a mobile device. This way a much higher level of 5 security is enforced.

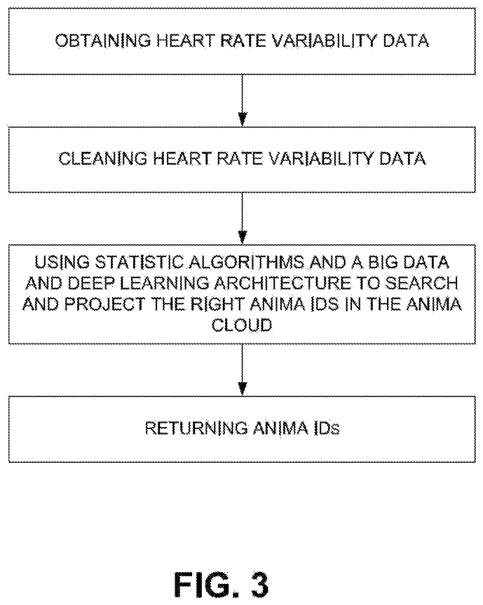

FIG. 3 is a flowchart of a method for authenticating users, in accordance with an exemplary embodiment. First, a heart rate variability data of a user is obtained. For example, as shown in

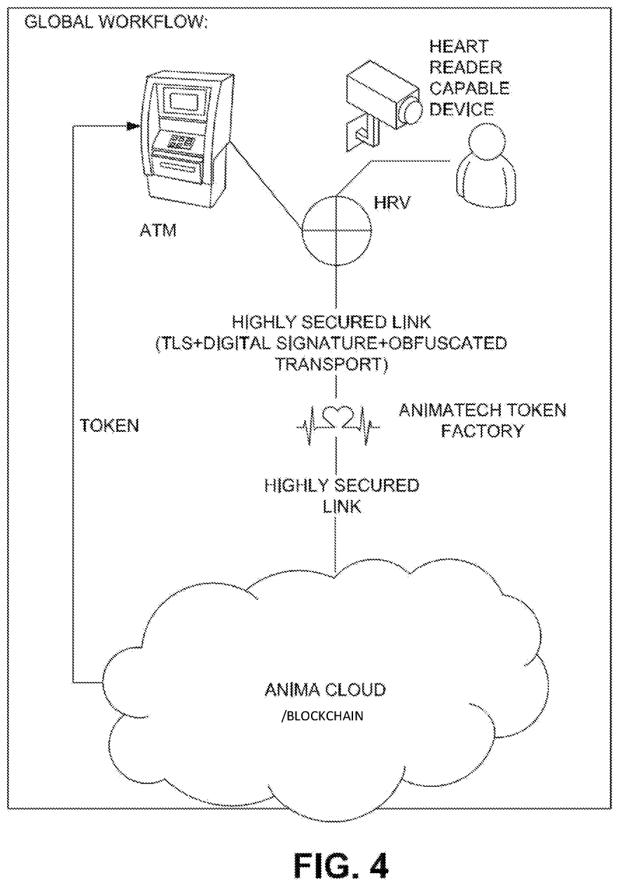

FIG. 4, a user may authenticate at an ATM using the “Anima ID”. A heart reader capable device is used to obtain the heart rate variability data of the user. The heart reader capable device may be an integral part of the ATM machine. Alternatively, an external heart reader capable device may be connected to the ATM machine. Thereafter, the obtained HRV data is cleaned. The cleaning of the HRV data provides a usable data (from a mathematical point of view). The cleaning of the HRV data may be performed by using high-end techniques, such as the Quasi-Newton optimization, and other techniques developed for Heart Rhythm analysis. The techniques may be specifically designed to identify anomalies in a heartbeat (such as extra beat, missed beat, early beat and late beat).

For example, as shown in FIG. 4, the HRV data may be cleaned at the ATM machine. Alternatively, the ATM machine may send the HRV data to the “Anima Cloud” where the HRV data may be cleaned. The HRV data may be sent to the “Anima Cloud” in a secure fashion by using one or more of TLS, digital signatures and obfuscated transport. Next, “Anima Cloud” makes deductions based on the clean data. The deductions that are empowered by the clean data are more accurate than the ones based on raw data.

The “Anima Cloud” may use statistic algorithms to project the possible identities that match the clean data. Further, the “Anima Cloud” may use a big data and deep learning architecture search to identify the matching “Anima IDs” (tokens), which may be returned, for example, to the ATM machine as shown in FIG. 4. 8 Further, the ATM machine may also use an identity management protocol (such as LDAP, X500) to enforce the identity of the user. Yet further, identity federation (such as SAML, OAuth) may be used.

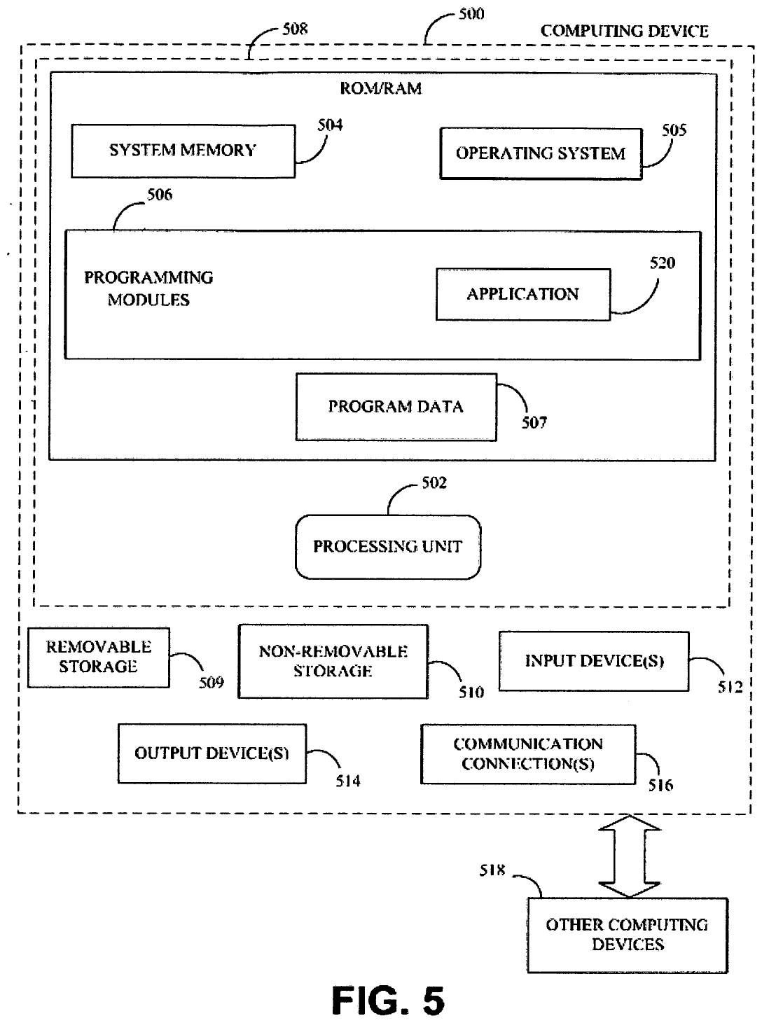

FIG. 5 is a block diagram of a system including computing device 500. Consistent with an embodiment of the disclosure, the aforementioned storage device and processing device may be implemented in a computing device, such as computing device 500 of FIG. 5. Any suitable combination of hardware, software, or firmware may be used to implement the memory storage and processing unit. For example, the storage device and the processing device may be implemented with computing device 500 or any of other computing devices 518, in combination with computing device 500. The aforementioned system, device, and processors are examples and other systems, devices, and processors may comprise the aforementioned storage device and processing device, consistent with embodiments of the disclosure.

With reference to FIG. 5, a system consistent with an embodiment of the disclosure may include a computing device or cloud service, such as computing device 15 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505, one or more programming modules 506, and may include a program data 507.

Operating system 505, for example, may be suitable for controlling computing device 500′s operation. In one embodiment, programming modules 506 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 5 by those components within a dashed line 508. Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer-readable instructions, data structures, program modules, or other data.

System memory 504, removable storage 509, 5 and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, etc. Output device(s) 514 such as a display, speakers, a printer, etc. may also be included.

The aforementioned devices are examples and others may be used. Computing device 500 may also contain a communication connection 516 that may allow device 500 to communicate with other computing devices 518, such as over a network in a distributed computing environment, for example, an intranet or the Internet. Communication connection 516 is one example of communication media.

Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal.

By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502, programming modules 506 (e.g., application 520 such as a media player) may perform processes including, for example, one or more stages of methods, algorithms, systems, applications, servers, databases as described above.

The aforementioned process is an example, and processing unit 502 may perform other processes. Other programming modules that may be used in accordance with embodiments of the present disclosure may include sound encoding/decoding applications, machine learning application, acoustic classifiers etc.

Generally, consistent with embodiments of the disclosure, program modules may include routines, programs, components, data structures, and other types of structures that may perform particular tasks or that may implement particular abstract data types.

Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices. Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. Embodiments of the present disclosure, for example, are described above with reference to block diagrams and/or operational illustrations of methods, systems, and computer program products according to embodiments of the disclosure.

The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM.

Further, the disclosed methods' stages may be modified in any manner, including by reordering stages and/or inserting or deleting stages, without departing from the disclosure.

What is claimed is:

1. A method, comprising: receiving physical, behavioural and medical biometric data from a camera (fixed or mobile), by a centralised computer (“Anima Cloud”—a cloud-based strong authentication solution for software applications, peer to peer networks, not restricted to but including blockchain to authenticate users) using advanced mathematical calculations and machine learning, or artificial intelligence, personal information for a first person from a source, wherein the personal information for the first person includes Heart Rate Variability (HRV) biometric information (physical, behavioural and medical); receiving, by the centralised computer, a request to identify, authenticate or collect diagnostic readings of a person, wherein the request to authenticate includes further biometric information; comparing, by the centralised computer, the further biometric information with the Heart Rate Variability (HRV) biometric information; determining, by the centralised computer, a similarity measure based on the comparison of the further biometric information with the first historical biometric information; and determining, by the centralised computer, whether to authenticate the person, and whether the first and further biometric information is trusted biometric information based on the similarity measure, wherein the determination of whether to authenticate the person and whether the first and further biometric information is trusted biometric information is based on the similarity measure and an amount of time between when the first historical biometric was captured and when the received further biometric information was captured, and wherein the determination of whether to authenticate the person and whether the first and further biometric information is trusted biometric information comprises comparing, by the centralised computer, the determined similarity measure to a similarity measure threshold, wherein the similarity measure threshold is adjusted based on the amount of time between when the first historical biometric was captured and when the received further biometric information was captured in order to issue an “Anima ID.”

2. The method of claim 1, using advanced mathematical calculations to use the captured physical, behavioural and medical biometric data to identify and authenticate a person to issue an “AnimaToken.”

3. The method of claim 1, using advanced mathematical calculations to use the captured biometric data to identify changes in HRV pattern to detect specific changes in the person for health indicators.

4. The method of claim 1, using advanced mathematical calculations to use the captured biometric data to identify changes in HRV pattern to detect specific changes in the person for substance use.

5. The method of claim 1, wherein a value of the similarity measure threshold is increased as the amount of time between when the first historical biometric was captured and when the received further biometric information was captured decreases.

6. The method of claim 1, wherein the determination of whether to authenticate the person and whether the first and further biometric information is trusted biometric information is also based on an absolute age of one of the first and further biometric information.

7. The method of claim 1, further comprising: selecting, by the centralised computer, information from the group comprising transaction data, the stored first Heart Rate Variability (HRV) historical biometric information, the received further biometric information, the determined similarity measure, and non-biometric for the person to be authenticated; calculating, by the centralised computer using a mathematical model, a high-risk transaction probability using the selected information; and comparing, by the centralised computer, the calculated high-risk transaction probability to a risk threshold, wherein when the high-risk transaction probability is greater than the risk threshold the request to authenticate is further evaluated to identify potential fraud.

8. The method of claim 1, further comprising: determining, by the centralised computer, whether the received biometric information is fraudulent biometric information; and adding, by the centralised computer, the fraudulent biometric information to a blacklist.

9. The method of claim 1, wherein the personal information from the source includes non-biometric information and the determination of whether to authenticate the person and whether the first and further biometric information is trusted biometric information is also based on the non-biometric personal information.

10. The method of the previous claim, wherein the non-biometric information includes geolocation or distance information.

11. The method of claim 1, wherein after it is determined that the first Heart Rate Variability (HRV) and further biometric information is not trusted biometric information, additional personal information is received by the centralised computer and the first and further biometric information is determined as trusted based on the received additional personal information.

12. The method of previous claim, wherein the additional personal information is received from the source.

13. The method of the previous claim, wherein the additional personal information is information related to an account of the first person.

14. The method of previous claim, wherein the source is one of a plurality of independent sources and the additional personal information is received from a different one of the plurality of independent sources.

15. The method of claim 1, wherein the source is one of a plurality of independent sources, additional non-biometric personal information is received from another one of the plurality of independent sources, and the determination of whether to authenticate the person and whether the first and further biometric information is trusted biometric information is also based on the non-biometric personal information received from the another one of the plurality of independent sources.

16. The method of claim, wherein the additional non-biometric information includes geolocation or distance information.

17. The method of claim 1, wherein the further biometric information is received by the centralised computer via an interactive voice response (IVR) system, the method further comprising: transferring the person to be authenticated from the IVR system to a live agent; receiving, during an interaction between the live agent and the person to be authenticated, third biometric information; and comparing the third biometric information with the first historical biometric information and the further biometric information to identify whether there are any anomalies between the compared biometric information.

18. The method of claim 1, wherein the determination of whether to authenticate the person and whether the first and further biometric information is trusted biometric information further comprises: determining, by the centralised computer, a status of an account for which the person is requesting authentication.

19. The method wherein the further biometric information is received by the centralised computer via an interactive voice response (IVR) system, the method further comprising: transferring the person to be authenticated from the IVR system to a live agent; receiving, during an interaction between the live agent and the person to be authenticated, third biometric information; and comparing the third biometric information with the first historical biometric information and the further biometric information to identify whether there are any anomalies between the compared biometric information.
